(19) United States
(12) Patent Application Publication
(10) Pub. No.: US 2026/0324830 A1
(43) Pub. Date: Oct. 22, 2026

(54) APPLIANCE HAVING A SENSOR

(71) Applicant: Dyson Technology Limited, Malmesbury, Wiltshire (GB)

(72) Inventors: Bartosz SLAK, Chippenham (GB); Michele BENETTI, Bristol (GB); Robert James Kenward MCDOUGALL, Swindon (GB); Thomas Alexander CARLYLE, Chippenham (GB)

(21) Appl. No.: 19/117,488

(22) PCT Filed: Oct. 4, 2023
(86) PCT No.: PCT/IB2023/059956

§ 371 Date: Apr. 1, 2025

(30) Foreign Application Priority Data
Oct. 7, 2022 (GB) 2214733.4

(51) Int. Cl. A45D 20/12; G01S 7/481; G01S 7/4865; G01S 17/10

(52) U.S. Cl. CPC A45D 20/122; G01S 7/4813; G01S 7/4865; G01S 17/10

(57) ABSTRACT

An appliance including a main unit to which one of a plurality of attachments is attachable, a sensor that can emit emissions and receive reflected emissions, and a control module. The control module is able to determine which of the plurality of attachments is attached to the main unit based on data output by the sensor.

### FIELD OF THE INVENTION

The present invention relates to an appliance having a sensor for sensing attachments.

### BACKGROUND OF THE INVENTION

Some appliances may comprise a number of different attachments. For example, a hair appliance may comprise different attachments for achieving different styling results. In some instances, it may be desirable for the appliance to determine which of the attachments is in use.

### SUMMARY OF THE INVENTION

The present invention provides an appliance comprising: a main unit to which one of a plurality of attachments is attachable; a sensor operable to emit emissions and receive reflected emissions; and a control module operable to determine which of the plurality of attachments is attached to the main unit based on data output by the sensor.

By employing the sensor, such as a time-of-flight sensor, the control module is able to determine remotely which of the attachments, if any, is in use. Rather than such a sensor, the appliance could conceivably comprise alternative means for determining which attachment is in use. For example, the main unit could comprise electrical contacts or mechanical switches, and each attachment may contact a different set of contacts or actuate a different arrangement of switches when attached. In another example, the main unit could comprise one or more Hall-effect sensors, and each attachment may comprise a unique arrangement of magnets. In each of these examples, the contacts, switches or sensors would need to be located at the interface with the attachment. However, packaging additional components at the interface of the main unit may be challenging. For example, there may be insufficient space for the components and/or the required cabling, or the conditions at the interface and/or the path taken by the cabling may be harsh (e.g., high temperatures). By employing a sensor operable to emit emissions and receive reflected emissions, such as a time-of-flight sensor, the sensor may be located remotely from the attachment and thus remotely from the interface. As a result, packaging of the sensor and routing of cables may be made easier. Moreover, the sensor is able to remotely sense different attachments without the need to provide the attachments with additional components, such as RFID tags or the like. Accordingly, different attachments may be sensed remotely in a relatively cost-effective manner. In examples, the sensor may be a time-of-flight sensor. In examples, the emissions may comprise electromagnetic radiation.

The appliance may comprise an electric component and the control module may be operable to control the electric component in response to the determination. The control module is therefore able to control the electric component differently for different attachments. This then has the benefit that operation of the appliance may be controlled automatically on the basis of the attachment that is in use. In some examples, the control module may be operable to control the input power to the electric component in response to the determination.

The electric component may be an electric motor or a heater, and the control module may be operable to control a speed of the electric motor or a temperature of the heater in response to the determination. The performance of the appliance may be improved by operating the electric motor at different speeds and/or by operating the heater at different temperatures based on the attachment that is in use. For example, the appliance may be a hair appliance, the electric motor may be used to generate an airflow, and the heater may be used to heat the airflow. Different attachments may then provide better drying or styling results at different flow rates and/or at different heat settings. In another example, the appliance may be a vacuum cleaner and the electric motor may be used to generate suction. Different attachments may then perform better at different suctions.

The appliance may comprise an airflow generator for drawing an airflow through the appliance, and the control module may be operable to control a characteristic of the airflow in response to the determination. Different attachments may deliver better results for different airflows. For example, the appliance may be a hair appliance and the attachments may comprise a diffuser and a concentrator. The diffuser may deliver better results when the airflow has lower flow rate. This is because the hair is moved less by the airflow and thus curls are better defined. By contrast, a concentrator may deliver better results when the airflow has a higher flow rate. For example, by employing a higher flow rate, drying and/or styling of the hair may be achieved more rapidly. In another example, the appliance may be a vacuum cleaner and the attachments may comprise a first suction nozzle for use on floors, and a second suction nozzle for use on upholstery. When used on floors, a higher suction may be beneficial to draw in more of the dirt. However, when used on upholstery, a higher suction may cause the upholstery to be sucked into and block the suction nozzle. Accordingly, better results may be achieved on upholstery with a lower suction.

The control module may be operable to control one or more of a flow rate and a temperature of the airflow. As noted in the preceding paragraph, different attachments may deliver better results for different flow rates. Additionally or alternatively, different attachments may deliver better results for different temperatures. For example, the appliance may be a hair appliance and at least one of the attachments may provide better styling results at a lower heat setting, and at least one of the attachments may provide better styling results at a higher heat setting. By controlling the flow rate and/or the temperature of the airflow in response to the attachment in use, better overall results may be achieved.

The appliance may be a hair appliance comprising a plurality of flow and heat settings, and the control module may be operable to select one of the settings based on the determination. As noted above, different attachments may deliver better results for different flow and/or heat settings. Accordingly, by selecting one of the plurality of settings based on the attachment in use, better drying and/or styling results may be achieved.

The appliance may comprise the plurality of attachments. Moreover, each attachment may comprise a portion configured to reflect emissions towards the sensor when attached to the main unit, the sensor may be operable to receive emissions emitted by the sensor and reflected by the portion of the attachment when attached to the main unit, and the attachments may differ such that the emissions reflected by the portion of each of the attachments differs. This then represents a relatively cost-effective manner for determining which of the attachments is attached to the main unit. In particular, discrimination of the attachments may be achieved through the use of relatively simple differences in the portions. In some examples, the portions may differ in size, shape, surface features, reflectivity, or any other feature that changes the way in which the emissions are reflected by the portions. In examples, the portions may differ in the wavelength or range of wavelengths of electromagnetic radiation that the portion reflects (such as differing in colour), and the sensor may be operable to sense the wavelength or range of wavelengths of received emissions (such as the colour of the received emissions).

The sensor may be operable to sense a time-of-flight of the emissions. For example, the sensor may be provided by a time-of-flight sensor. A projection of the portion towards the sensor may differ for different attachments. For example, the attachments may differ in the extent to which the portion projects towards the sensor. For example, the portion of each of the plurality of attachments may comprise a projection that projects towards the sensor when the attachment is attached to the main unit. The projections may have different sizes such that the projection of each of the attachments, when attached to the main unit, projects towards the sensor by a different amount. The distance between the sensor and the projection therefore differs for different attachments. This is then reflected in the data output by the sensor, which the control module uses to determine which of the attachments, if any, is attached to the main unit. As another example, the attachments may differ in the pattern or shape according to which the portion projects towards the sensor. For example, the portion may comprise a plurality, for example an array, of projections. Each one of the projections may project towards the sensor by a certain amount, and in doing so may encode an identity of the attachment. For example, this may be analogous to a bar code. The pattern of projections may differ for different attachments. The set or pattern of distances of the projections from the sensor for a given portion is then reflected in the data output by the sensor, which the control module may then use to determine which of the attachments, if any, is attached to the main unit. For example, the control module may map the set or pattern of distances onto one of a plurality of patterns each associated with a different attachment, thereby to determine which attachment is attached to the main unit.

The sensor may be operable to sense an intensity of the reflected emissions, and a reflectivity of the portion may differ for different attachments. Reflectivity may be taken as a measure of the extent to which a surface reflects incident emissions, such as radiation. For example, a time-of-flight sensor may be used to sense an intensity of the reflected emissions, as well as a time-of-flight of the emissions. As another example, the sensor may comprise a detector configured to detect the intensity of the reflected emissions but not necessarily the time-of-flight of the emissions. The reflectivity of the portion may differ for different attachments. The intensity of emissions reflected from the portion and received by the sensor may therefore differ for different attachments. This then may be reflected in the data output by the sensor, which the control module uses to determine which of the attachments, if any, is attached to the main unit. Different reflectivity may be provided, for example, by different surface textures or finishes, material transparency, and/or any other feature or property that affects the extent to which emissions are reflected by the portion to the sensor.

The projection of each of the attachments may comprise a semi-transparent material, and the transparency of the semi-transparent material may differ for different attachments. The emissions reflected by the projection may therefore have a different signature for different attachments, which may in turn be used to determine which of the attachments, if any, is attached to the main unit.

At least one of the attachments may be attachable to the main unit in any one of a plurality of rotational positions about an axis of the main unit. For example, when attached, the at least one attachment may be free to rotate relative to the main unit about the axis, for example a central longitudinal axis of a barrel section of the main unit. The attachment being attachable in any one of a plurality of rotational positions may allow that a user is able to achieve a desired direction and angle of airflow without having to hold or manipulate the appliance at uncomfortable angles. The control module may be operable to additionally determine the rotational position of the at least one attachment relative to the main unit when the at least one attachment is attached to the main unit. This allows for the control module to determine the rotational position of the attachment. This may, in turn, allow the control module to control the appliance depending on the determined rotational position. For example, this may have the benefit that operation of the appliance may be controlled automatically on the basis of the rotational position of the attachment relative to the main unit. For example, the appliance may comprise an electric component (such as a heater and/or an airflow generator) and the control module is operable to control the electric component in response to the rotational position determination. For example, the rotational position of the attachment relative to the unit may be changed manually by a user and thereby provide a means by which the user may control the appliance to operate in a particular mode. As another example, an attachment orientated at different rotational positions relative to the main unit (and hence relative to e.g. a handle of the main unit) may provide for optimal styling when the appliance is operated differently. Accordingly, this may provide for improved styling. The control module may be operable to determine simultaneously both the attachment and the rotational position of the attachment.

The appliance may comprise the at least one attachment, the at least one attachment may be configured to reflect emissions towards the sensor when the attachment is attached to the main unit, and the sensor may be operable to receive emissions emitted by the sensor and reflected by the attachment when attached to the main unit. The at least one attachment may comprise a plurality of portions distributed about the axis when the attachment is attached to the main unit, and each of the plurality of portions may reflect emissions to the sensor differently. The different portions distributed about the axis reflecting emissions differently allows a simple and cost-effective way for the control module to determine the rotational position of the attachment. In some examples, the portions may differ in size, shape, projection towards the sensor, a pattern according to which the portion projects towards the sensor, surface features, reflectivity, or any other feature that changes the way in which the emissions are reflected by the portions.

The sensor may be configured to emit emissions towards a reference rotational position about the axis, and the rotational position of the at least one attachment may be determined based on emissions reflected by one or more of the portions at the reference rotational position. This may allow for a relatively simple and cost-effective way to provide for determination of the rotational position. For example, the sensor may emit emissions to the reference rotational position and may receive emissions reflected by whichever portion of the attachment is located at the reference rotational position. Since the different portions reflect the emissions differently, the portion that is located at the reference rotational position will be encoded in the reflected emissions received by the sensor and hence encoded into the data output by the sensor. The control module may then determine the rotational position of the attachment based on this output data. For example, the control module may store a mapping of different output data (encoding different portions of the attachment) onto different rotational positions. The control module may match a current output data to one of the stored output data, and thereby determine, via the mapping, the rotational position to which the current output data corresponds.

The sensor may comprise a two-dimensional array of receivers operable to receive the emissions emitted by the sensor and reflected by one or more of the portions of the attachment when attached to the main unit. This may allow for accurate rotational position determination and/or for flexibility in the implementation of the plurality of portions of the at least one attachment. For example, whereas a single receiver may allow determination of a distance or reflectivity of a portion of the attachment, a two-dimensional array of receivers may (alternatively or additionally) allow for determination of a position of the portion of an attachment in a plane. For example, the at least one attachment may comprise, distributed about the rotational axis, a first portion configured to reflect emissions to the sensor, and a second portion configured to reflect emissions to the sensor differently to the first portion (including, for example, to not reflect emissions at all). When the attachment is rotated and the first portion is accordingly at different rotational positions, different receivers of the two-dimensional array of receivers may receive emissions reflected by the first portion differently. For example, different receivers may receive different intensities of reflected emissions and/or with different times-of-flight. For example, a receiver located closest to the first portion may receive the most reflected emissions from the first portion and/or with the shortest time-of-flight. In any case, the reflected emissions being received differently at different receivers may encode the rotational position of the first portion about the axis, and the control module may accordingly determine the rotational position of the attachment based on the data output by the sensor.

A surface of the main unit may comprise an anti-reflective component configured to reduce the extent to which emissions are reflected from the surface of the main unit. This may reduce the extent to which the emissions reflect from one or more surfaces of the main unit, and hence may reduce the background emissions received by the sensor. For example, background emissions may comprise emissions originating external to the appliance and/or emissions originating from the sensor but which are reflected by the main unit and hence which do not carry any information about the attachment or another body external to the main unit. Reducing the background may, in turn, improve the signal-to-noise ratio of the sensor. This may, in turn, improve the precision and/or resolution with which the control module can make the determinations mentioned above. For example, the distance resolution (that is, the minimum distance by which targets must be separated to be separately distinguishable) of a TOF sensor may be expressed as a function of signal-to-noise ratio and integration time. Accordingly, increasing the signal-to-noise ratio may allow for the distance resolution to be reduced and/or for the integration time to be reduced. Reducing the distance resolution may allow, for example, for the projections of different attachments to be made more similar to one another, which may, for example, help reduce manufacturing costs. Reducing the integration time may allow for the determinations to be made faster. Alternatively, or additionally, reducing the background may allow for the radial size of the portion and/or the reflectivity of the portion to be reduced for a given determination precision. Reducing the radial size of the portion and/or the reflectivity of the portion may, for example, help reduce manufacturing costs. In examples, the anti-reflective component may comprise an anti-reflective coating applied to the surface. In examples, the anti-reflective coating may comprise an absorbing material that absorbs the emissions. Where the emissions are electromagnetic radiation, the anti-reflective coating may comprise, for example, layers of dielectric material configured to reduce reflectivity for a given wavelength of emissions. In examples, the anti-reflective component may comprise a baffle or other structure applied to the surface and configured to reduce the extent to which emissions are reflected from the surface to the sensor. For example, the baffle structure may comprise a series of spaced apart plates projecting from the surface and extending in a direction perpendicular to the sensor axis, although other structures are possible. Other components configured to reduce the extent to which emissions are reflected from the surface of the main unit may be used.

The control module may be operable to additionally determine a proximity of an object relative to the appliance based on the data output by the sensor. This then has the advantage that the sensor is used for at least two purposes: (i) to determine which of the plurality of attachments is attached to the main unit (and possibly also the rotational position of the attachment), and (ii) to determine the proximity of an object to the appliance. The control module may be operable to determine simultaneously both the attachment (and possibly also the rotational position of the attachment) and the proximity of the object based on the data output by the sensor. The object may be that on which the appliance operates. For example, the object may be a user, a surface, a workpiece, or the like.

The appliance may comprise an electric component and the control module may be operable to control the electric component in response to the proximity determination. The control module is therefore able to control the electric component based on the proximity of the object to the appliance. For example, if the object is too close to the appliance, the electric component may be controlled (e.g., powered down) to prevent or reduce potential damage to the object and/or the appliance. In another example, if the object is too far from the appliance, the electric component may be controlled (e.g., powered down) to reduce power consumption and/or noise. In some examples, the control module may control the power to the electric component based on the proximity of the object. For example, the control module may power on and off the electrical component based on the proximity of the object. In another example, the control module may decrease the power of the electric component as the object approaches the appliance, and increase the power as the object retreats from the appliance. As noted above, the electric component may comprise an electric motor or a heater, and the control module may be operable to control a speed of the electric motor or a temperature of the heater in response to the proximity determination. The performance of the appliance may then be improved by operating the electric motor at a speed and/or by operating the heater at a temperature that depends on the proximity of the object. For example, as the object approaches the appliance, the control module may decrease the speed of the electric motor and/or decrease the temperature of the heater. Conversely, as the object retreats from the appliance, the control module may increase the speed of the electric motor and/or increase the temperature of the heater. In this way, a similar level of performance may be achieved by the appliance irrespective of distance of the object relative to the appliance.

The appliance may comprise an airflow generator for drawing an airflow through the appliance, and the control module may be operable to control a characteristic of the airflow in response to the proximity determination. As a result, the performance of the appliance may be improved by controlling the airflow based on the proximity of the object. For example, the appliance may be a hair appliance and the object may be the hair of a user. When the hair is relatively close to the appliance, a high flow rate may move the hair excessively resulting in unsatisfactory styling results and/or a high temperature may over-dry or damage the hair. Accordingly, the control module may decrease the flow rate and/or the temperature of the airflow as the hair approaches the appliance in order to achieve better styling results. In another example, the appliance may be a vacuum cleaner and the object may be a surface to be cleaned. The control module may then control the flow rate of the airflow based on proximity of surface. For example, when the surface is relatively far from the appliance, the control module may power down or power off the airflow generator to reduce power consumption and/or noise.

The appliance may comprise the plurality of attachments. Moreover, each of the attachments may comprise a path through which the emissions travel between the sensor and the object. This then has the advantage that, when attached to the main unit, each attachment may be located between the sensor and the object. The path in each of the attachments then ensures that the emissions are not obstructed by the attachment and thus the proximity of the object may be determined.

The emissions may comprise electromagnetic radiation, and the path may comprise one or more optical windows. This then provides a relatively cost-effective mechanism for ensuring that the emissions are free to travel, through the attachment, between the sensor and the object. An optical window of one or more attachments may comprise a hole in the attachment, which further reduces the cost of the attachment. However, depending on the appliance and/or the attachment, the provision of a hole in the attachment may compromise the performance. Accordingly, an optical window of one or more of the attachments may comprise a transparent or semi-transparent member. The optical window may have an optical property that differs for different attachments. Emissions reflected by the optical window may then be used to determine which of the attachments is attached to the main unit. For example, where the optical window comprises a transparent or semi-transparent member, the transparency of the member may differ for different attachments. In other examples, the reflection or refraction of the optical window may differ for different attachments.

The appliance may be a hair appliance and the object may be the hair of a user. As noted above, by determining the proximity of the head to the appliance, better drying and/or styling results may be achieved. For example, a warning or other indication may be generated to indicate to a user that their head is too close and/or too far from the appliance. In other examples, the control module may control the flow rate and/or the temperature of the airflow based on the proximity of the head.

The sensor may be a time-of-flight sensor, the main unit may comprise an end face to which the one of a plurality of attachments is attachable, and a shortest distance between the sensor and the end face may be at least 20 mm. This then has the advantage that a path of reasonable length may be established between the time-of-flight sensor and each of the attachments. As a result, a more robust determination may be made of which attachment is attached to the main unit.

The main unit may comprise a barrel section having a central bore, the one of a plurality of attachments may be attachable to an end of the barrel section, and the sensor may be located within the bore. This this has the benefit that a direct, unobstructed path may be provided between the sensor and the attachment. Additionally, emissions may be better confined within the appliance. Furthermore, for appliances that already have an existing bore, the sensor may be incorporated without increasing the overall size of the appliance.

At least one of the plurality of attachments, when attached to the main unit, may be rotatable relative to the main unit about a rotational axis, and the sensor may be located on the rotational axis. As a result, the control module is able to determine which of the plurality of the attachments is attached to the main unit irrespective of the rotational position of the attachment.

According to a second aspect of the invention, there is provided an appliance comprising: a main unit to which at least one attachment is attachable in any one of a plurality of rotational positions about an axis of the main unit; a sensor operable to emit emissions and receive reflected emissions; and a control module operable to determine the rotational position of the at least one attachment relative to the main unit when the at least one attachment is attached to the main unit. In examples, the appliance may comprise the at least one attachment, the at least one attachment may be configured to reflect emissions towards the sensor when the attachment is attached to the main unit, and the sensor may be operable to receive emissions emitted by the sensor and reflected by the attachment when attached to the main unit. The at least one attachment may comprise a plurality of portions distributed about the axis when the attachment is attached to the main unit, and each of the plurality of portions may reflect emissions to the sensor differently.

### BRIEF DESCRIPTION OF THE DRAWINGS

Embodiments will now be described, by way of example only, with reference to the accompanying drawings in which:

FIG. 1 is an isometric view of an appliance;

FIG. 2 is a side sectional view through a centre of a main unit of the appliance;

FIG. 3 is a rear view of the main unit;

FIG. 4 is a schematic of electric components of the main unit;

FIG. 5 is a side sectional view of part of the appliance in which an attachment is attached to the main unit;

FIG. 6 is the same view as that FIG. 5, in which cones of sensing of a time-of-flight sensor are shown;

FIG. 7 is a schematic diagram illustrating a rear view of an attachment according to an example; and

FIG. 8 is a schematic diagram illustrating a rear view of an attachment according to another example.

### DETAILED DESCRIPTION OF THE INVENTION

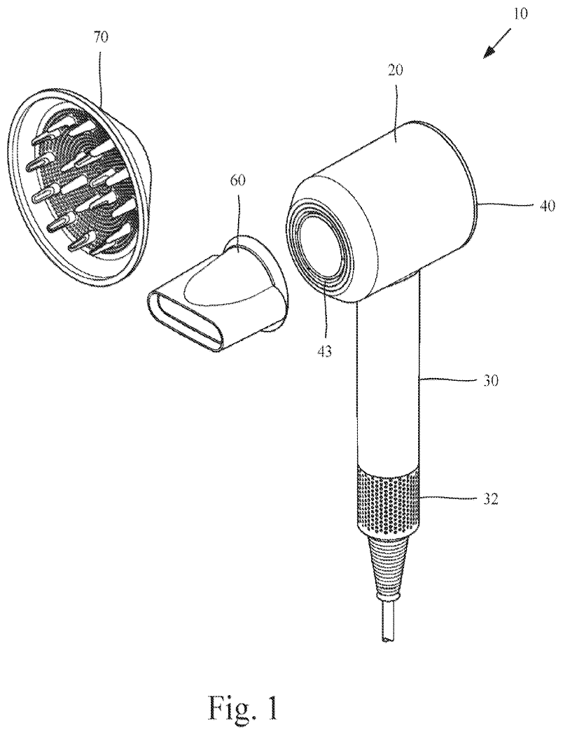

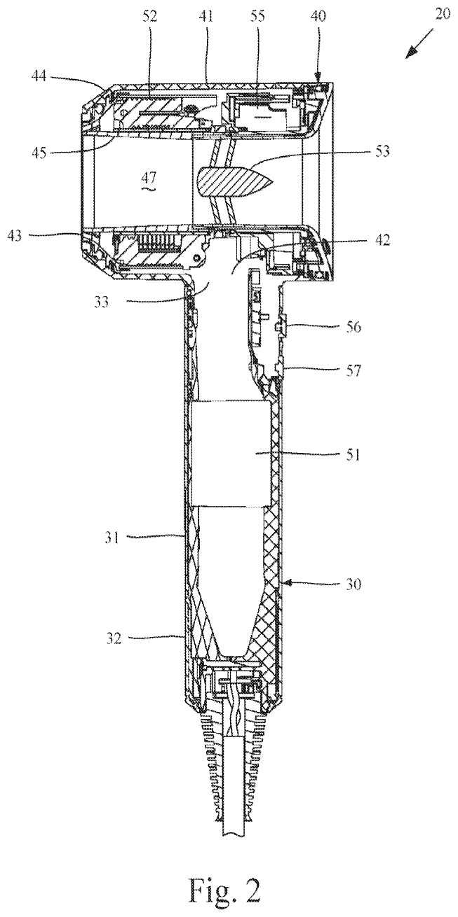

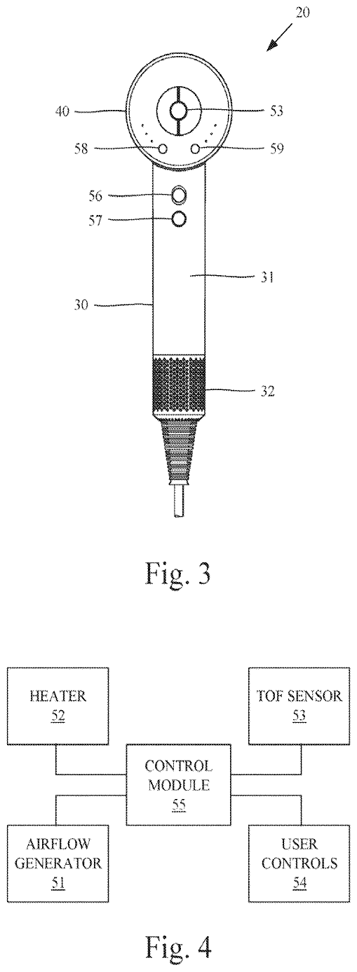

The appliance 10 of FIGS. 1 to 6 comprises a main unit 20 and a plurality of attachments 50,60, each of which is attachable to the main unit 20. In the present example, the appliance 10 is a haircare appliance, and attachments 60,70 comprise a concentrator 60 and a diffuser 70.

The main unit 20 comprises a handle section 30 and a barrel section 40.

The handle section 30 is generally cylindrical in shape and comprises a housing 31 that houses an airflow generator 51. The housing comprises an inlet 32 through which an airflow is drawn into the handle section 30 by the airflow generator 51, and an outlet 33 through which the airflow is discharged into the barrel section 40. The airflow generator 51 comprises a fan driven by an electric motor.

The barrel section 40 is likewise generally cylindrical in shape, but is shorter in length and wider in diameter than the handle section 30. The barrel section 40 is attached to an end of the handle section 30 and is oriented such that the longitudinal axes of the handle section 30 and the barrel section 40 are orthogonal. As a result, the shape of the main unit 20 resembles a gavel or mallet.

The barrel section 40 comprises a housing 41 that houses a heater 52 and a control module 55. The housing 41 comprises an outer wall 44 and an inner wall 45 that are generally concentric and define a chamber within which the heater 52 and the control module 55 are housed. The housing 41 comprises an inlet 42 through which airflow from the handle section 30 enters the chamber, and an outlet 43 at an end of the barrel section 40 through which the airflow is discharged. The heater 52 is located between the inlet 42 and the outlet 43 and, when powered, heats the airflow. The inner wall 45 defines a bore 47 that extends through the centre of the barrel section 40.

The main unit 20 further comprises a sensor 53, in this example a time-of-flight (TOF) sensor 53, and user controls 54.

The TOF sensor 53 is located within the bore 47 of the barrel section 40. In this example, the TOF sensor 53 is an integrated package or all-in-one system that comprises an emitter, a receiver, and a processor. The emitter emits emissions, which in this example are photons of electromagnetic radiation. The emitter emits the emissions as discrete pulses or groups of pulses, with a frequency typically of the order of MHz. By way of example, the emitter may emit groups of pulses at a frequency of around 43 MHz, and each group may comprise at least 80,000 pulses. In other examples, the emissions may comprise acoustic (e.g., ultrasonic) pulses. The receiver then receives reflected emissions, which have been reflected and returned to the TOF sensor 53. The processor then determines time differences between emitting and receiving the emissions and from this calculates distances between the TOF sensor 53 and targets responsible for the reflected emissions. The processor then outputs this distance data to the control module 55.

As explained below in more detail, the TOF sensor 53 is used to sense which, if any, of the attachments 60,70 is attached to the main unit 20. Additionally, the TOF sensor 53 is used to sense the proximity of a user's head or other object to the appliance 10. In the present example, the control module 55 analyses the distance data output by the TOF sensor 53 and from this analysis determines (i) which attachment, if any, is attached to the main unit 20 and (ii) the proximity of the head of a user. In one example, the distance data may take the form of a histogram, e.g., distance vs number of photons. In another example, the distance data may comprise the number of targets that were detected by the TOF sensor 53 within one or more ranges and/or the distance of the target within each range. In other examples, the TOF sensor 53 itself, rather than the control module 55, may analyse the distance data and output data indicative of which attachment, if any, is attached to the main unit 20 and/or the proximity of a user's head. In each of these examples, the control module 55 nevertheless determines which of the attachments 60,70, if any, is attached to the main unit 20 and the proximity of the user's head based on the data received from the TOF sensor 53. The control module 55 then uses this determination to control the flow rate and/or the temperature of the airflow, as described further below.

The user controls 54 are provided on both the handle section 30 and the barrel section 40, and comprise a first button 56 or slider to power on and off the appliance 10, a second button 57 to momentarily power off the heater 52 such that the appliance 10 delivers a cold shot of air, a third button 58 to control the flow rate of the airflow, and a fourth button 59 to control the temperature of the airflow.

The control module 55 is responsible for controlling the airflow generator 51 and the heater 52 in response to inputs from the TOF sensor 53 and the user controls 54. For example, in response to inputs from the user controls 54, the control module 55 may power on and off the airflow generator 51 and/or the heater 52. Additionally, the control module 55 may control the power or speed of the airflow generator 51 in order to vary the flow rate of the airflow. For example, repeatedly pressing the third button 58 may cause the control module 55 to cycle through different flow rates (e.g., low, medium and high). Similarly, the control module 55 may control the power of the heater 52 in order to vary the temperature of the airflow. For example, repeatedly pressing the fourth button 59 may cause the control module 55 to cycle through different temperature settings (e.g., cold, warm, hot).

The control module 55 also controls the airflow generator 51 and/or the heater 52 in response to the data output by the TOF sensor 53. As a result, better drying and/or styling results may be achieved. For example, different attachments may deliver better drying or styling results when using different flow rates and/or temperatures. The diffuser 70, for example, is likely to deliver better results when the airflow has a lower flow rate. By employing a lower flow rate, the hair is moved less by the airflow and thus curls may be better defined. By contrast, the concentrator 60 is likely to deliver better results when the airflow has a higher flow rate. In another example, if the head of the user is too close to the appliance, a high flow rate may move the hair excessively resulting in unsatisfactory styling results and/or a high temperature may over-dry or damage the hair. Accordingly, by controlling the flow rate and/or the temperature of the airflow based on which attachment, if any, is attached and/or the proximity of the head of the user, better styling results may be achieved.

The control module may store a plurality of different flow and temperature settings, and the control module may select one of the plurality of settings based on which of the attachments is attached to the main unit. For example, the control module may store a default flow and temperature setting for each of the attachments. Additionally, or alternatively, the control module may store the flow and temperature setting selected by a user when last using a particular attachment.

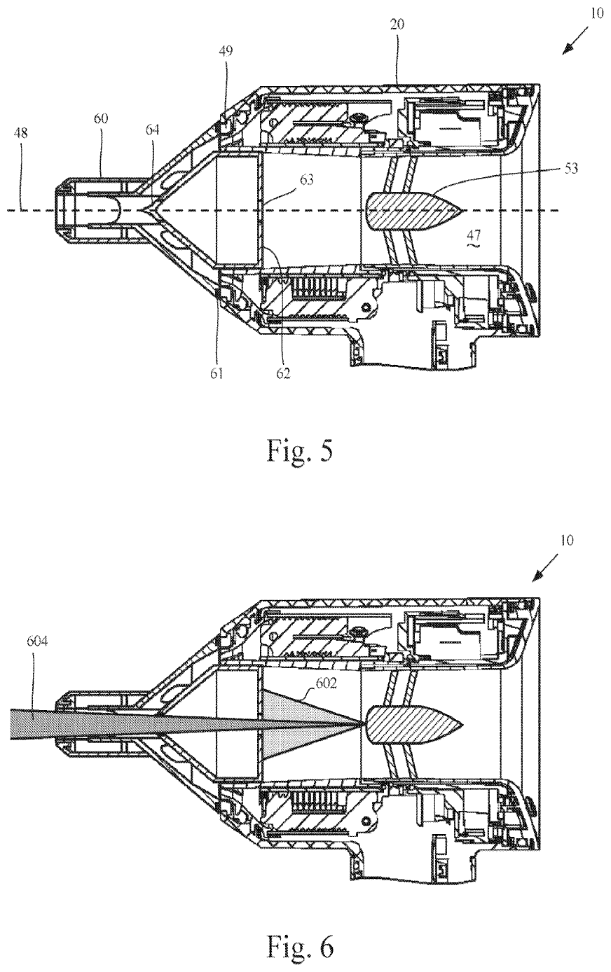

FIGS. 5 and 6 illustrate an arrangement in which one of the attachments, in this instance the concentrator 60, is attached to the main unit 20.

Each of the attachments 60,70 is attached to an end of the barrel section 40 of the main unit 20. When attached, each of the attachments 60,70 is free to rotate relative to the main unit 20 about the central longitudinal axis 48 of the barrel section 40. This then has the advantage that a user is able to achieve a desired direction and angle of airflow without having to hold or manipulate the appliance 10 at uncomfortable angles. In the present example, each of the attachments 60,70 comprises an annular magnet 61, and the barrel section comprises a ferrous ring 49 to which the magnet 61 is attracted to secure the attachment 60,70 in place. However, other mechanisms for achieving a rotatable attachment of the attachment 60,70 to the main unit 20 are possible.

Each of the attachments 60,70 comprises a projection 62 that projects into the bore 47 of the barrel section 40 towards the TOF sensor 53. The emissions emitted by the TOF sensor 53 reflect off the projection 62 and are returned to the TOF sensor 53. The projections 62 of the attachments 60,70 then differ such that the emissions reflected by the projection of each attachment differ, e.g., have a different signature. In this example, the projections 62 differ in size. More particularly, lengths of the projections 62 differ such that, when a particular attachment 60,70 is attached to the main unit 20, the projection 62 projects towards the TOF sensor 53 by a different amount to those of other attachments 60,70. The distance between the TOF sensor 53 and the projection 62 therefore differs for different attachments 60,70. This is then reflected in the data output by the TOF sensor 53, which the control module 55 uses to determine which of the attachments 60,70, if any, is attached to the main unit 20.

In this example, the projections 62 of the attachments 60,70 differ in size, and more particularly in their lengths. In other examples, the projections 62 may differ in additional or alternative ways, such as shape, surface features, or indeed any other feature that changes the way in which emissions are reflected by the projection 62. By way of example, the projection of each attachment may include a semi-transparent material, perhaps covering a reflective material, and the transparency of the material may differ for different attachments. Providing each attachment 60,70 with a projection 62 that differs from that of other attachments 60,70 offers a relatively cost-effective solution for discriminating between different attachments 60,70. Nevertheless, the attachments 60,70 may comprise alternative features that reflect emissions from the TOF sensor 53 differently.

As noted, each of the each of the attachments 60,70 is free to rotate relative to the main unit 20 about the longitudinal axis 48 of the barrel section 40. The TOF sensor 53 is then located on the longitudinal axis 48 (i.e., the rotational axis of the attachment 60,70). As a result, the TOF sensor 53 receives the same reflected emissions from an attachment 60,70 irrespective of the rotational position of the attachment 60,70. The TOF sensor 53 is therefore capable of sensing which of the attachments 60,70 is attached to the main unit 20 irrespective of the rotational position of the attachment 60,70.

The TOF sensor 53 is set reasonably far back in the bore 47 of the barrel section 40. In this example, the distance between the TOF sensor 53 and the end of the barrel section 40 (i.e., that end to which the attachments 60,70 attach) is around 45 mm. This then has the advantage that a path of reasonable length is established between the TOF sensor 53 and the projection 62 of each of the attachments 60,70. As a result, a more robust determination may be made of which attachment 60,70 is attached to the main unit 20. To this end, the distance between the TOF sensor 53 and the end of the barrel section 40 may be no less than 20 mm.

As noted above, the TOF sensor 53 is also used to sense the proximity of the head of a user, or other objects relative to the appliance 10. In the absence of any attachment 60,70, the TOF sensor 53 has an unobstructed path through the bore 47 of the barrel section 40. As a result, the TOF sensor 53 is able to sense emissions reflected by the head of a user proximate to the outlet 43 of the appliance 10.

Each of the attachments 60,70 comprises a path through which emissions are able to travel between the TOF sensor 53 and the head of a user. Accordingly, when an attachment 60,70 is attached to the main unit 20, the TOF sensor 53 continues to have a path or line-of-sight to the head of the user. In this particular example, the TOF sensor 53 emits photons of light (e.g., visible or infrared) and each of the attachments 60,70 comprises an optical path through the attachment 60,70. In this example, the optical path is linear and comprises one or more optical windows 63,64 in the attachment 60,70. In other examples, the path through the attachment 60,70 may be non-linear and may comprise one or more optical elements (e.g., mirrors and/or lenses) for redirecting the path of the emissions. Each of the optical windows 63,64 may comprise a hole or a transparent member. In some examples, one or both of the optical windows 63,64 may comprise a semi-transparent member, and the transparency of the member may differ for different attachments 60,70. Emissions reflected by the semi-transparent member may then be used to determine which of the attachments 60,70 is attached to the main unit 20.

The TOF sensor 53 is therefore able to sense simultaneously (i) which attachment 60,70, if any, is attached to the main unit, and (ii) the proximity of the head of a user. Conceivably, the TOF sensor 53 may be used to sense just one these. In particular, the TOF sensor 53 may be used to sense only which attachment 60,70, if any, is attached to the main unit 20. The main unit 20 may comprise more than one TOF sensor. For example, the main unit 20 may comprise a first TOF sensor for sensing which attachment 60,70, if any, is attached to the main unit 20, and a second TOF sensor for sensing the proximity of the head of a user. In another example, the main unit 20 may comprise a plurality of TOF sensors, each of which senses both the attachment and the proximity of the user's head, in order to provide a more robust determination.

Rather than a TOF sensor 53, the main unit 20 could conceivably comprise alternative means for determining which attachment 60,70 is in use. For example, the main unit 20 could comprise electrical contacts or mechanical switches, and each attachment 60,70 may contact a different set of contacts or actuate a different arrangement of switches when attached. In another example, the main unit 20 could comprise one or more Hall-effect sensors, and each attachment 60,70 may comprise a unique arrangement of magnets. In each of these examples, the contacts, switches or sensors would need to be located at the end of the barrel section 40 that interfaces with the attachment 60,70. However, packaging additional components at the interface of the main unit 20 may be challenging. For example, there may be insufficient space for the components and/or the required cabling, or the conditions at the interface and/or the path taken by the cabling may be harsh (e.g., high temperatures). For example, in the present example, there is relatively little space available at the end of the barrel section 40, and the heater 52 is located between the end of the barrel section 40 and the control module 55. By employing a TOF sensor 53, the sensor 53 may be located remotely from the attachment 60,70 and the end of the main unit 20 that interfaces with the attachment 60,70. As a result, packaging of the TOF sensor 53 and routing of cables between the TOF sensor 53 and the control module 55 may be made easier. Furthermore, by employing a TOF sensor 53, different attachments 60,70 may be discerned without the need to provide the attachments 60,70 with additional components, such as RFID tags or the like. Accordingly, different attachments 60,70 may be sensed remotely in a relatively cost-effective manner.

In the present example, each of the attachments 60,70 is attachable to an end of the barrel section 40 of the main unit 20, and the TOF sensor 53 is located within the bore 47 of the barrel section 40. This has the benefit that a direct, unobstructed path may be provided between the TOF sensor 53 and each of the attachments 60,70. Additionally, stray emissions may be better confined within the appliance 10. Furthermore, for appliances that already have an existing bore, the TOF sensor 53 may be incorporated within the main unit without increasing the overall size.

In examples, one or more surfaces of the main unit 20 may comprise an anti-reflective component configured to reduce the extent to which emissions are reflected from the one or more surfaces of the main unit 20 to the sensor 53. For example, the surface of the inner wall 45 defining the bore 47 in which the sensor 53 is located may have an anti-reflective component applied. The anti-reflective component may reduce the extent to which the emissions emitted by the sensor 53 reflect from the one or more surfaces of the main unit 20, and hence may reduce the background emissions received by the sensor 53. For example, background emissions may comprise emissions originating from the sensor 53 but which are reflected by the main unit 20 and hence which do not carry any information about the attachment 60, 70 or another body external to the main unit 20. In some examples, the anti-reflective component may comprise an anti-reflective coating applied to the one or more surfaces of the main unit 20. For example, where the emissions are electromagnetic radiation, the anti-reflective coating may comprise, for example, layers of dielectric material configured to reduce reflectivity for a given wavelength of emissions. In some examples, the anti-reflective component may comprise a baffle or other structure (not shown) applied to the one or more surfaces of the main unit 20. The baffle structure (not shown) may, for example, comprise a series of plates extending from the surface of the main unit 20 and arranged to reduce the extent to which emissions are reflected from the surface to the sensor 53. Other components configured to reduce the extent to which emissions are reflected from the surface of the main unit 20 may be used.

In the example described above, the appliance 10 is a haircare appliance that emits an airflow for drying and styling hair. The control module 55 of the appliance 10 then controls the flow rate and/or the temperature of the airflow based on data output by the TOF sensor 53. In particular, the flow rate and/or the temperature may be controlled according to which attachment 60,70, if any, is in use. Additionally, the flow rate and/or the temperature may be controlled according to the proximity of a user's head to the appliance 10.

The principles described above may be used with other types of appliance having a plurality of different attachments. For example, the appliance may be a vacuum cleaner having a main unit to which one of a plurality of different attachments may be attached. The main unit may comprise an airflow generator that generates suction at each of the attachments. The attachments may comprise a first suction nozzle for use on floors, and a second suction nozzle for use on upholstery. When used on floors, a higher suction may be beneficial to draw in more of the dirt. However, when used on upholstery, a higher suction may cause the upholstery to be sucked into and block the suction nozzle. Accordingly, better results may be achieved on upholstery with a lower suction. The main unit may therefore comprise a TOF sensor that senses which of the attachments is attached, and a control module that controls the suction of the airflow generator based on the data output by the TOF sensor. In another example, the appliance may be a power tool or the like that comprises an electric motor for driving different attachments. A TOF sensor may sense which of the attachments is attached, and a control module may control the speed and/or torque of the electric motor based on the data output by the TOF sensor. Accordingly, in a more general sense, the appliance 10 may be said to comprise a main unit 20 to which one of a plurality of attachments 60,70 is attachable. The appliance comprises a TOF sensor 53 and a control module 55 that is operable to determine which of the plurality of attachments 60,70 is attached to the main unit 20 based on data output by the TOF sensor 53. The control module may then control an electrical component (e.g., an electric motor, an airflow generator or a heater) in response to the determination.

In the examples described above, the sensor 53 is a time-of-flight sensor 53. However, this need not necessarily be the case and the sensor 53 may be any sensor operable to emit emissions and receive reflected emissions (of which a time-of-flight sensor 53 is an example).

Further, in the examples described above the different attachments 60, 70, each comprise a projection 62 that projects towards the sensor 53 by different amounts. However, this need not necessarily be the case and in examples each attachment 60, 70 may comprise any portion (of which a projection 62 is an example) configured to reflect emissions towards the sensor when the attachment 60, 70 is attached to the main unit 20, where the attachments 60, 70 differ such that the emissions reflected by the portion of each of the attachments 60, 70 differs.

In some examples, the attachments 60, 70 may differ in the pattern or shape according to which the portion 62 projects towards the sensor. For example, the portion may comprise a plurality, for example an array, of projections. Each one of the projections may project towards the sensor 53 by a certain amount, and in doing so may encode an identity of the attachment 60, 70. For example, this may be analogous to a bar code. The pattern of projections may differ for different attachments. The set or pattern of distances of the projections from the sensor 53 for a given portion is then reflected in the data output by the sensor, which the control module 55 may then use to determine which of the attachments, if any, is attached to the main unit 20. For example, the control module 55 may map the set or pattern of distances onto one of a plurality of patterns each associated with a different attachment 60, 70, thereby to determine which attachment 60, 70 is attached to the main unit 22.

In some examples, among different attachments 60, 70, the portion may differ in size, shape, projection towards the sensor, a pattern according to which the portion projects towards the sensor, surface features, reflectivity, colour, or any other feature that changes the way in which the emissions are reflected by the portion.

For example, the sensor 53 may be operable to sense an intensity of the reflected emissions (without necessarily being operable to sense a time-of-flight of the emissions). In such cases, for example, the reflectivity of a portion of each attachment 60, 70 may differ for different attachments 60, 70. Accordingly, for different attachments 60, 70, the sensor 53 will sense different intensities of received emissions, which may be encoded in the data output by the sensor 53. Accordingly, the control module 55 may determine which attachment 60, 70, if any, is attached to the main unit based on the data output by the sensor 53. In examples, the sensor 53 may be configured to emit emissions at a certain wavelength and receive reflected emissions only at that certain wavelength. This may help improve the sensitivity of the sensor 53.

As another example, the sensor 53 may be operable to sense a wavelength or range of wavelengths of received emissions (such as the colour of the received emissions). In such cases, the wavelength or range of wavelengths of electromagnetic radiation that a portion of each attachment 60, 70 reflects (such as the colour of the portion) may differ for different attachments. Accordingly, the control module 55 may determine which attachment 60, 70, if any, is attached to the main unit based on the data output by the sensor 53.

Accordingly, it will be appreciated that in some examples, each attachment 60, 70 may comprise a portion 62 configured to reflect emissions towards the sensor 53 when the attachment 60, 70 is attached to the main unit 20. The sensor 53 may be operable to receive emissions emitted by the sensor 53 and reflected by the portion 62 of the attachment 60, 70 when attached to the main unit 20. The attachments 60, 70 may differ such that the emissions reflected by the portion 62 of each of the attachments 60, 70 differs. For example, the sensor 53 (e.g. the TOF sensor 53) may be operable to sense a time-of-flight of the emissions, and a projection of the portion 62 towards the sensor 53 may differ for different attachments 60, 70. For example, the portion 62 of each of the plurality of attachments 60, 70 may comprise a projection 62 that projects towards the sensor 53 when the attachment 60, 70 is attached to the main unit 20, and the projections 62 may have different sizes such that the projection 62 of each of the attachments 60, 70, when attached to the main unit, projects towards the sensor 53 by a different amount. As another example, the sensor (e.g. the TOF sensor 53 or another sensor) may be operable to sense an intensity of the reflected emissions, and a reflectivity of the portion 62 may differ for different attachments 60, 70.

In some examples described above, the control module 55 uses the data output by the TOF sensor 53 to determine both the attachment 60, 70 attached to the main unit 20 and the proximity of an object (such as a user's head) relative to the appliance. In some examples, the control module 55 may be configured to monitor two ranges of TOF distances from the sensor 53: a first range in which the portion 62 of an attachment 60, 70 may be positioned when attached to the main unit 52, and a second range (e.g. non-overlapping with the first range and at greater distances than the first range) in which an object may be positioned. The control module 55 may monitor these two ranges separately to determine which attachment 60, 70, if any, is attached to the main unit 20 and to determine the proximity of an object to the appliance, respectively.

However, some examples, such as where the sensor 53 is operable to sense an intensity of the reflected emissions (without necessarily being operable to sense a time-of-flight of the emissions), other approaches may be used to determine both the attachment and the proximity of the object.

For example, the sensor 53 may comprise two emitters. A first emitter may be configured to emit emissions onto a portion 62 of an attachment 60, 70 when attached to the main unit 20. A second emitter may be configured to emit emissions onto an object. For example, the second emitter may be configured to emit emissions through the attachment 60, 70 when attached to the main unit 20, such as through the optical window 63. For example, referring briefly to FIG. 6, the first emitter may be configured to emit according to a wider cone 602, and the second emitter may be configured to emit according to a narrower cone 604. Output data associated with emissions from the first emitter may be used to determine which attachment, if any, is attached to the main unit 20, and output data associated with the second emitter may be used to determine the proximity of the object to the appliance. The emissions from the first and second emitter may be discriminated, for example, by configuring the first emitter and the second emitter to emit in different time slots to one another. By monitoring data output by the sensor 53 in the different time slots, the control module 55 is able to determine both which attachment 60, 70, if any, is attached to the main unit 20 and the proximity of an object to the appliance. In other examples, the sensor may comprise a plurality of receivers. A first receiver may be configured to receive emissions reflected from a portion 62 of an attachment 60, 70 when the attachment 60, 70 is attached to the main unit. A second receiver may be configured to receive emissions reflected from an object. For example, referring again briefly to FIG. 6, the first receiver may be configured to have a field of view according to a wider cone 602, and the second receiver may be configured to have a field of view according to a narrower cone 604. As another example, the first receiver may be positioned radially offset from the optical window 63 and the second receiver may be positioned in-line with the optical window 63. In either case, the output data associated with the first receiver may be used to determine which attachment, if any, is attached to the main unit 20, and the output data associated with the second receiver may be used to determine the proximity of an object to an appliance. In other examples, the senor may comprise two pairs of emitters and receivers, a first pair associated with sensing the attachment, and a second pair associated with sensing the object. The first and second pairs may operate, for example, with different fields of view, in different time slots and/or with different wavelengths, thereby to allow discrimination in the data output by the sensor 53 between output data associated with sensing the attachment 60, 70 and output data associated with sensing the object. Other configurations may be used.

In the above examples, the attachments 60, 70 are attachable to the main unit 20 in any one of a plurality of rotational positions about an axis 48 of the main unit. Specifically, in the above examples, when attached, each of the attachments 60,70 is free to rotate relative to the main unit 20 about the central longitudinal axis 48 of the barrel section 40. In some examples, the control module 55 may be operable to additionally determine the rotational position of the attachment 60, 70 relative to the main unit when the attachment 60, 70 is attached to the main unit 20. That is, the control module 55 may be configured to determine, based on the data output by the sensor 53, one or more of (i) which attachment 60, 70, if any, is attached to the main unit 20, (ii) a rotational position of an attachment 60, 70 attached to the main unit 20, and (iii) a proximity of an object to the appliance.

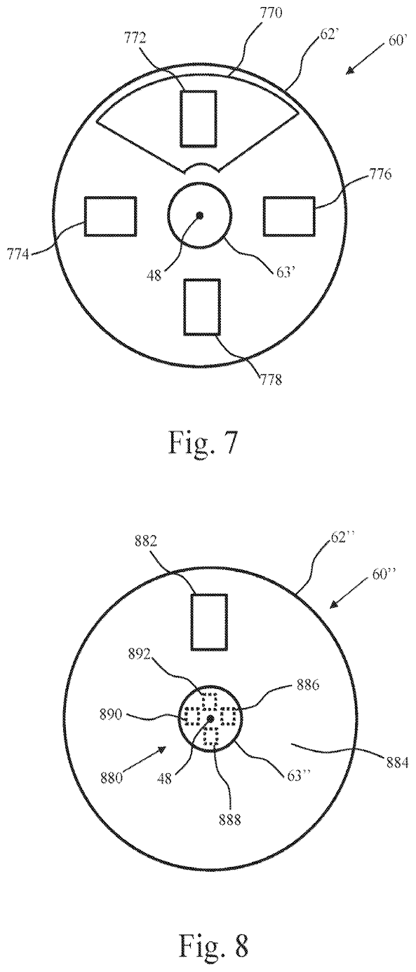

Example approaches to determining the rotational position of an attachment attached to the main unit 20 are described with reference to FIGS. 7 and 8. FIGS. 7 and 8 show two different example approaches, respectively. Both of FIGS. 7 and 8 show a schematic view of a part of an example attachment 60′, 60″ as viewed along the rotational axis 48 of the attachment 60′, 60″ from the perspective of the sensor of the main unit (not shown in FIGS. 7 and 8). In these examples, the part comprises the projection 62′, 62″ of the attachment 60′, 60″, and the projection 62′, 62″ has an optical window 63′, 63″. However, in other examples the attachment 60′, 60″ need not necessarily comprise the projection 62′, 62″ and another part or parts of the attachment 60′, 60″ could be used. In some examples, the attachment 60′, 60″ may have one or more of the features of the attachments 60, 70 described above with reference to FIGS. 1 to 6.

In the examples of both FIGS. 7 and 8, the attachment 60′, 60″, specifically the projection 62′, 62″ of the attachment 60′, 60″, comprises a plurality of portions 772-778, 882, 884 distributed about the axis 48, and each of the plurality of portions 772-778, 882, 884 are configured to reflect emissions to the sensor differently. For example, on a given attachment 60′, 60″, the portions 772-778, 882, 884 may differ in size, shape, projection towards the sensor, a pattern according to which the portion projects towards the sensor, surface features, reflectivity, or any other feature that changes the way in which the emissions are reflected by the portions. Since the portions 772-778, 882, 884 distributed around the axis 48 reflect emissions differently, the sensor may receive reflected emissions differently depending on the rotational position of the attachment 60′, 60″ about the axis. Accordingly, the control module 55 may determine the rotational position of the attachment based on the data output by the sensor.

Referring now specifically to the example of FIG. 7, the attachment comprises a plurality of portions 772-778 (in this example four portions) distributed about the axis 48. The sensor (not shown) is configured to emit emissions towards a reference rotational position 770 about the axis 48. For example, the reference rotational position may be at 12'oclock or zero degrees in the sense of FIG. 7. The rotational position of the attachment 60′ may be determined based on emissions reflected by the portion 722 at the reference rotational position 770. For example, the sensor emits emissions to the reference rotational position 770 and receives emissions reflected by whichever portion of the attachment is located at the reference rotational position (in FIG. 7, the portion labelled 772). Since the different portions 772-778 reflect the emissions differently, the portion 772 that is located at the reference rotational position 770 will be encoded in the reflected emissions received by the sensor and hence encoded into the data output by the sensor. The control module 55 may then determine the rotational position of the attachment based on this output data.

In examples, the emissions may be emitted towards the reference rotational position 770 and not towards other rotational positions. This may be provided by, for example, configuring the sensor to emit emissions at the reference rotational position 700, and/or by applying a mask (not shown) between the sensor and the attachment 60′ such that emission from the sensor is transmitted to the reference rotational position 770 and not to other rotational positions. In some examples, the sensor may emit emissions to both the reference rotational position 770 and through the optical window 48. This may allow for the determination of one or more of (i) which attachment 60′, if any, is attached to the main unit 20 (ii) the rotational position of the attachment 60′ and (iii) the proximity of an object to the appliance. As one illustrative example, the sensor may comprise a single TOF sensor 53. The attachment 60′ that is attached to the main unit 20 may be determined based on the projection 62′ (e.g. the portions 772-778) being within a certain range of distances from the sensor. The rotational position of the attachment 60′ may be determined based on the portion 772 located at the reference position 770 being a certain distance from the sensor (e.g. within the certain range). The proximity of the object may be determined based on receiving reflected emissions that have travelled over a certain threshold distance (e.g. greater than the distance from the sensor to the distal end of the attachment and back). Other configurations are possible.

Referring now specifically to the example of FIG. 8, the attachment 62″ comprises a plurality of portions 882, 884 (in this example two portions) distributed about the axis 48. Specifically, in this example, a first portion 882 is configured to reflect emissions towards the sensor, and a second portion 884, which comprises the surface of the projection 62″ other than the first portion 882, is configured to reflect emissions differently to the first portion. For example, the second portion 884 may be configured to not reflect emissions towards the sensor at all or to do so to a lesser extent than the first portion 882. In this example, the sensor emits emissions generally towards the projection 62″ (not necessarily only in a specific reference rotational position). In this example, the sensor comprises a two-dimensional array 880 of receivers 886-892 (in this example a 2 by 2 array) operable to receive the emissions emitted by the sensor and reflected by the first portion 882 of the attachment 60″ when attached to the main unit 20. The receivers 886-892 are distributed about the rotational axis 48 and are arranged in a plane perpendicular to the axis 48. In FIG. 8, the receivers 886-892 are shown with dotted lines to convey that they are set back from the projection 62″, for example as per the sensor 53 in other examples described herein.

The two-dimensional array 880 of receivers 886-892 may allow for determination of a position of the first portion 882 of the attachment 60″ in a plane perpendicular to the rotational axis 48, and hence for determination of the rotational position of the attachment 60″ about the axis 48 relative to the main unit 20. For example, when the attachment 60″ and hence the first portion 882 is in different rotational positions, different receivers of the two-dimensional array 880 of receivers 886-892 may receive emissions reflected by the first portion 882 differently. For example, where the first portion 882 has a different reflectivity to the second portion 884, different receivers may receive different intensities of reflected emissions depending on the rotational position of the first portion 882. For example, the receiver 892 located closest to the first portion 882 may receive the most reflected emissions from the first portion 882. As another example, where the first portion 882 projects towards the sensor by a different amount than the second portion 884, different receivers may receive reflected emissions with different times-of-flight depending on the rotational position of the first portion 882. For example, a receiver 892 located closest to the first portion 882 may receive emissions reflected from the first portion with the shortest time-of-flight. In this case, the control module may determine that the rotational position of the attachment 60″ is that in which the first portion 882 is closest to the receiver 892. In either case, the reflected emissions being received differently at different receivers 886-892 may encode the rotational position of the first portion 882 about the axis 48, and the control module may accordingly determine the rotational position of the attachment 60″ based on the data output by the sensor.

Whilst particular examples and embodiments have thus far been described, it should be understood that these are illustrative only and that various modifications may be made without departing from the scope of the invention as defined by the claims.

1. An appliance comprising:
a main unit to which one of a plurality of attachments is attachable;
a sensor operable to emit emissions and receive reflected emissions; and
a control module operable to determine which of the plurality of attachments is attached to the main unit based on data output by the sensor.

2. The appliance as claimed in claim 1, wherein the appliance comprises an electric component and the control module is operable to control the electric component in response to the determination, and/or wherein the appliance is a hair appliance comprising a plurality of flow and heat settings, and the control module is operable to select one of the settings based on the determination.

3. The appliance as claimed in claim 2, wherein the electric component is an electric motor or a heater, and the control module is operable to control a speed of the electric motor or a temperature of the heater in response to the determination.

4. (canceled)

5. The appliance as claimed in claim 1, wherein the appliance comprises the plurality of attachments, each attachment comprises a portion configured to reflect emissions towards the sensor when the attachment is attached to the main unit, the sensor is operable to receive emissions emitted by the sensor and reflected by the portion of the attachment when attached to the main unit, and the attachments differ such that the emissions reflected by the portion of each of the attachments differs.

6. The appliance as claimed in claim 5, wherein the sensor is operable to sense a time-of-flight of the emissions, and a projection of the portion towards the sensor differs for different attachments.

7. the appliance as claimed in claim 6, wherein the portion of each of the plurality of attachments comprises a projection that projects towards the sensor when the attachment is attached to the main unit, and the projections have different sizes such that the projection of each of the attachments, when attached to the main unit, projects towards the sensor by a different amount.

8. The appliance as claimed in claim 5, wherein the sensor is operable to sense an intensity of the reflected emissions, and a reflectivity of the portion differs for different attachments.

9. The appliance as claimed in claim 8, wherein the portion of each of the attachments comprises a semi-transparent material, and the transparency of the semi-transparent material differs for different attachments.

10. The appliance as claimed in claim 1, wherein at least one of the attachments is attachable to the main unit in any one of a plurality of rotational positions about an axis of the main unit, and the control module is operable to additionally determine the rotational position of the at least one attachment relative to the main unit when the at least one attachment is attached to the main unit.

11. The appliance as claimed in claim 10, wherein the appliance comprises an electric component and the control module is operable to control the electric component in response to the rotational position determination.

12. The appliance as claimed in claim 10, wherein the appliance comprises the at least one attachment, the at least one attachment is configured to reflect emissions towards the sensor when the attachment is attached to the main unit, the sensor is operable to receive emissions emitted by the sensor and reflected by the attachment when attached to the main unit, the at least one attachment comprises a plurality of portions distributed about the axis when the attachment is attached to the main unit, and each of the plurality of portions reflect emissions to the sensor differently.

13. The appliance as claimed in claim 12, wherein the sensor is configured to emit emissions towards a reference rotational position about the axis, and the rotational position of the at least one attachment is determined based on emissions reflected by one or more of the portions at the reference rotational position, and/or wherein the sensor comprises a two-dimensional array of detectors operable to receive the emissions emitted by the sensor and reflected by one or more of the portions of the attachment when attached to the main unit.

14. (canceled)

15. The appliance as claimed in claim 1, wherein a surface of the main unit comprises an anti-reflective component configured to reduce the extent to which emissions are reflected from the surface of the main unit, and/or wherein the sensor comprises a time-of-flight sensor, the main unit comprises an end face to which the one of a plurality of attachments is attachable, and a distance between the time-of-flight sensor and the end face is at least 20 mm, and/or wherein the main unit comprise a barrel section having a central bore, the one of a plurality of attachments is attachable to an end of the barrel section, and the sensor is located within the bore, and/or wherein at least one of the plurality of attachments, when attached to the main unit, is rotatable relative to the main unit about a rotational axis, and the sensor is located on the rotational axis, and/or wherein the appliance is a hair appliance.

16. The appliance as claimed in claim 1, wherein the control module is operable to additionally determine a proximity of an object relative to the appliance based on the data output by the sensor.

17. The appliance as claimed in claim 16, wherein the appliance comprises an electric component and the control module is operable to control the electric component in response to the proximity determination, and/or wherein the appliance comprises the plurality of attachments, and each of the attachments comprises a path through which the emissions travel between the sensor and the object and, optionally, wherein the path comprises an optical window and, optionally, the optical window has an optical property that differs for different attachments, and/or wherein the appliance is a hair appliance and the object is the head of a user.

18-25. (canceled)
